(19) United States
(12) Patent Application Publication
(10) Pub. No.: US 2024/0305552 A1
(43) Pub. Date: Sep. 12, 2024

(54) MANAGING ACTIVE AND STANDBY GATEWAYS USING DUPLICATE ADDRESS DETECTION PACKETS

(71) Applicant: VMware LLC, Palo Alto, CA (US)

(72) Inventor: Ankit Kumar Sinha, Bangalore (IN)

(21) Appl. No.: 18/181,643

(22) Filed: Mar. 10, 2023

(51) Int. Cl. H04L 43/106; H04L 9/40; H04L 12/46; H04L 43/028

(52) U.S. Cl. CPC H04L 43/106; H04L 12/46; H04L 43/028; H04L 63/20

(57) ABSTRACT

Described herein are systems, methods, and software to manage an active/standby gateway configuration using Duplicate Address Detection (DAD) packets. In one implementation, a first gateway determines that a heartbeat connection with a second gateway has failed. In response to the failed heartbeat connection, the first gateway implements a packet filter for the data plane that permits DAD packets but blocks one or more other protocols. The first gateway then determines whether a response is received to the DAD packets within a timeout period. If received, the first gateway will revert to a standby state. If not received, the first gateway will assume the active state in place of the second gateway.

### TECHNICAL BACKGROUND

In computing environments, edge gateways or edges are used to provide connectivity between computing resources, such as host computers for virtual endpoints (virtual machines, containers, and the like), and external networks. An edge gateway can provide various operations on ingress and egress packets, including firewall operations, filtering operations, encryption/decryption, encapsulation, or some other operation with respect to the packets. For example, a packet may be received at an edge from an external network, processed by the edge, and forwarded to a destination host computer.

In many implementations, edge gateways can be deployed in a high availability configuration that permits a first gateway to act as a failover or standby version of a gateway. However, issues can arise when the connection or bridge between the active gateway and the standby gateway is lost. Specifically, when the standby gateway is unable to determine whether the active edge gateways is available, the standby gateway cannot definitively determine when to assume the active state in the computing environment. This can cause packets to be processed by neither gateway (i.e., dropped) or packets to be processed at both gateways.

### SUMMARY

The technology described herein manages active and standby gateways based on Duplicate Address Detection (DAD) packets. In one implementation, a method of operating a first gateway includes maintaining a standby state for a second gateway in an active state and identifying a loss of a heartbeat connection with the second gateway. The method further includes, in response to identifying the loss of heartbeat connection, applying a packet filter in a data plane, wherein the packet filter permits DAD packets and block other data plane traffic. The method also provides communicating a DAD packet in the data plane and determining whether a response to the DAD packet is received within a timeout period. When a response to the DAD packet is received within the timeout period, the method further includes maintaining the standby state. In contrast, when a response to the DAD packet is not received within the timeout period, the method provides for moving to the active state.

### BRIEF DESCRIPTION OF THE DRAWINGS

FIG. 1 illustrates a computing environment to manage active and standby gateways using Duplicate Address Detection (DAD) packets according to an implementation.

FIG. 2 illustrates an operation of a gateway to use DAD packets to manage transitions from a standby state to an active state according to an implementation.

FIG. 3 illustrates an operational scenario of using DAD packets to determine that the active gateway is available according to an implementation.

FIG. 4 illustrates an operational scenario of using DAD packets to determine that the active gateway is unavailable according to an implementation.

FIG. 5 illustrates a gateway computing system that uses DAD packets to determine whether to transition from a standby state to an active state according to an implementation.

### DETAILED DESCRIPTION

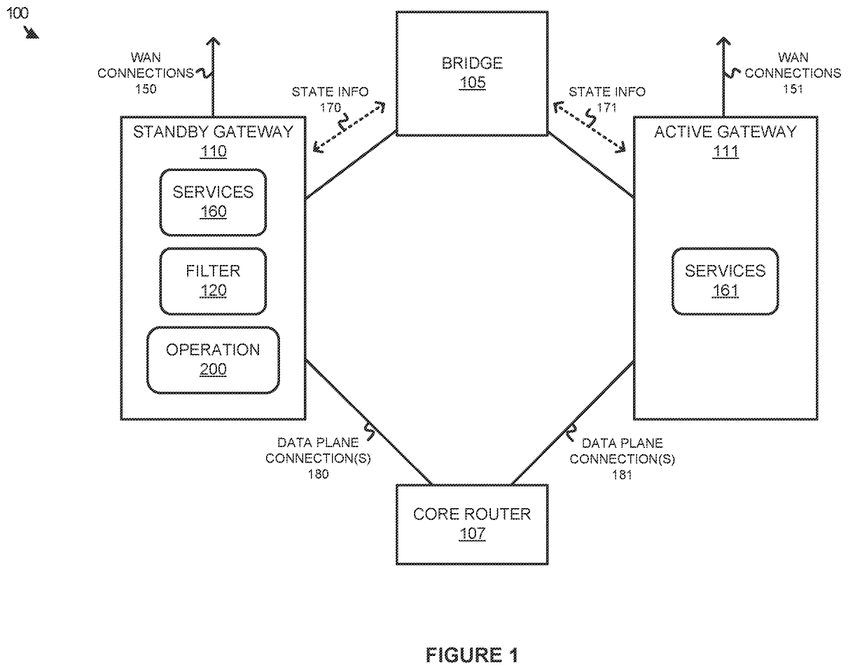

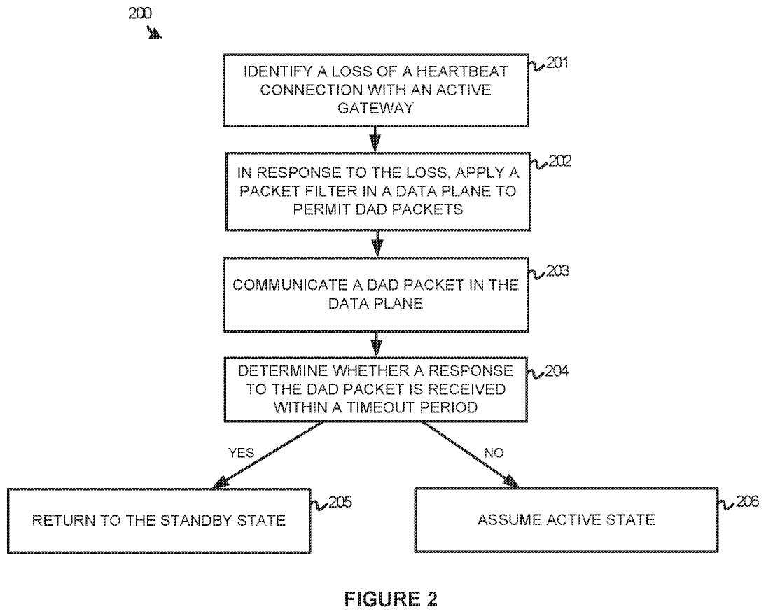

FIG. 1 illustrates a computing environment 100 to manage active and standby gateways using Duplicate Address Detection (DAD) packets according to an implementation. Computing environment 100 includes bridge 105, core router 107, standby gateway 110, and active gateway 111. Standby gateway 110 further includes filter 120, services 160, and operation 200 that is further described below in FIG. 2. Active gateway 111 further includes service 161. Standby gateway 110 and active gateway 111 communicate state information 170-171 via bridge 105, wherein the state information can include heartbeat messages, firewall status information, or some other information between the active and standby gateways 110-111. Core router 107 is used to provide connectivity to other networks and provides data plane connection(s) 180-181. Gateways 110-111 provide wide area network (WAN) connections 150-151 to one or more computing systems (not pictured), wherein the computing systems can comprise host computers for virtual machines, containers, or other virtualized endpoints. Although demonstrated with a single core router 107, each gateway of gateways 110-111 can be coupled to multiple core routers, wherein each of the core routers can correspond to a different internet service provider.

In computing environment 100, gateways 110-111 are representative of edge gateways or edges that can provide various services 160-161 for computing devices (physical and/or virtual) in the computing environment. Gateways 110-111 can represent routers, servers, or some other computing device capable of providing the operations described herein. Gateways 110-111 are coupled to core router 105 that is representative of a router that is in a higher tier than gateways 110-111. Core router 105 can be used to connect the computing devices (not pictured) to outside networks. For example, a packet can be received at core router 105 and forwarded to active gateway 111 based on forwarding rules associated with the packet. Active gateway 111 then processes the packet using services 161 and can forward the packet toward the destination computing device using WAN connections 151. In processing the packet, active gateway 111 can provide firewall operations, filtering operations, encryption/decryption operations, or some other operation with respect to the packet.

Here, to provide failover operations associated with active gateway 111, standby gateway 110 is provided that can support the services of active gateway 111 after a failure of gateway 111. The failure can include a hardware failure, software failure, connection failure, or some other failure. To monitor the health associated with active gateway 111, gateways 110-111 can exchange state information 170-171, which can include heartbeat messages or packets. The heartbeat packets can be communicated periodically to indicate whether active gateway 111 is available to support the networking operations for the connected computing devices. State information 170-171 can further include networking state information, such as firewall state information, or some other stateful information associated with the processing of packets at active gateway 111.

When standby gateway 110 determines that a heartbeat packet was not received from active gateway 111 within a timeout period, standby gateway 110 can apply filter 120 that is used to permit DAD packets in the data plane, while blocking packets associated with other protocols. Thus, packets received that are not related to a DAD packet will be dropped, while DAD packets are permitted to be received and processed. In addition to setting filter 120, standby gateway 110 will send one or more DAD packets using one or more ports that are coupled to core router 107 via data plane connection(s) 180. The DAD packet will advertise that standby gateway is using the same address or addresses as active gateway 111. After sending the DAD packets, standby gateway 110 will wait for a response from active gateway 111, wherein a response would indicate that active gateway is still using the one or more addresses. If a response is received within a timeout period, then standby gateway will remain in a standby state. If the response is not received within the timeout period, then the standby gateway will move to an active state and act in place of active gateway 111. By transitioning to the active state, standby gateway 110 will implement services 160 that provide the same functionality as services 161 in active gateway 111.

FIG. 2 illustrates an operation 200 of a gateway to use DAD packets to manage transitions from a standby state to an active state according to an implementation. The steps of operation 200 are referenced parenthetically in the paragraphs that follow with reference to systems and elements of computing environment 100 of FIG. 1.

Operation 200 includes identifying (201) a loss of a heartbeat connection with an active gateway 111. The heartbeat connection is used by gateways 110-111 to indicate state or health information to the other gateway. For example, using the heartbeat connection, active gateway 111 can periodically communicate a packet that indicates that active gateway 111 is healthy and available to provide the desired operations in computing environment 100. When the connection is interrupted, either through a failed connection using bridge 105 or a failure of active gateway 111, standby gateway 110 will not receive a heartbeat packet within a timeout period and will identify a loss of the heartbeat connection.

In response to identifying the loss of the heartbeat connection, operation 200 further applies (202) a packet filter 120 in a data plane to permit DAD packets and block other types of packets, including one or more other protocols. Advantageously, while standby gateway can send and receive packets related to determining whether a duplicate address is in use by the current active gateway, the standby gateway will not process other types of packets, such as UDP, TCP, or other types of protocols.

Once the filter is applied, operation 200 further communicates (203) one or more DAD packets in the data plane using one or more ports coupled to the data plane. The one or more ports can be used to communicate with active gateway 111 using core router 107. For example, standby gateway 110 can be coupled to core router 107 using two ports and can send a DAD packet using each of the ports. The DAD packets can be used to determine whether active gateway is still actively using the IP addresses that are mirrored by standby gateway 110. After sending the one or more DAD packets, standby gateway 110 will determine (204) whether a response to the one or more DAD packets are received within a timeout period. If a response to the one or more DAD packets is received within the timeout period, operation 200 returns (205) to the standby state, wherein the standby state will not accept packets from core router 107. In contrast if a response to the one or more DAD packets is not received within the timeout period, operation 200 moves (206) the standby gateway to an active state. In moving to the active state, standby gateway 110 can remove the filter or rules associated with blocking the other protocols outside of DAD packets and can implement services 160. Services 160 are a duplicated version of services 161, permitting standby gateway 110 to provide the same functionality as active gateway 111. In the example, of moving to the active state, standby gateway 110 can determine that active gateway 111 is unavailable based on the lack of response to the DAD requests in the data plane.

In some implementations, when standby gateway 110 remains in the standby state, standby gateway 110 can determine whether the heartbeat connection or state connection between gateways 110-111 is reestablished during a threshold period. If the connection is reestablished during the threshold period, then standby gateway may take no additional action in determining whether active gateway 111 is available. However, if the heartbeat connection is not reestablished during the threshold period, standby gateway 110 can repeat the process of sending DAD packets to check the availability of active gateway 111. Specifically, standby gateway 110 can activate the filter that permits DAD packets and drops packets associated with other protocols. Standby gateway 110 can then send the one or more additional DAD packets and determine whether a response to the one or more additional DAD packets is received. If received, standby gateway will return to the standby state. However, if not received, standby gateway 110 will move to the active state. This threshold period for reestablishing the heartbeat connection can be repeated indefinitely until the connection is reestablished.

In some implementations, once standby gateway 110 is moved to the active state, standby gateway 110 can monitor for when active gateway 110 becomes available again based on a reestablishment of the heartbeat connection. Once the heartbeat connection is reestablished, standby gateway 110 can continue as the active gateway, while active gateway 111 acts as the standby gateway. Alternatively, standby gateway 110 can return to the standby state and active gateway 111 can assume the active state once the heartbeat connection is reestablished.

Although demonstrated in the previous example with a failure of the heartbeat connection using bridge 105, other failures can occur in association with active gateway 111. For example, active gateway 111 can identify a failure associated with WAN connections 151 and generate a notification that is provided as part of state information 170-171 to standby gateway 110. In response to receiving the notification, standby gateway 110 can move to the active state to assume the operations of active gateway. Here, unlike the previous example of the failure associated with the heartbeat notifications and the heartbeat connection, active gateway 111 can communicate a notification to standby gateway 110 to move to the active state, eliminating the requirement of the DAD packets.

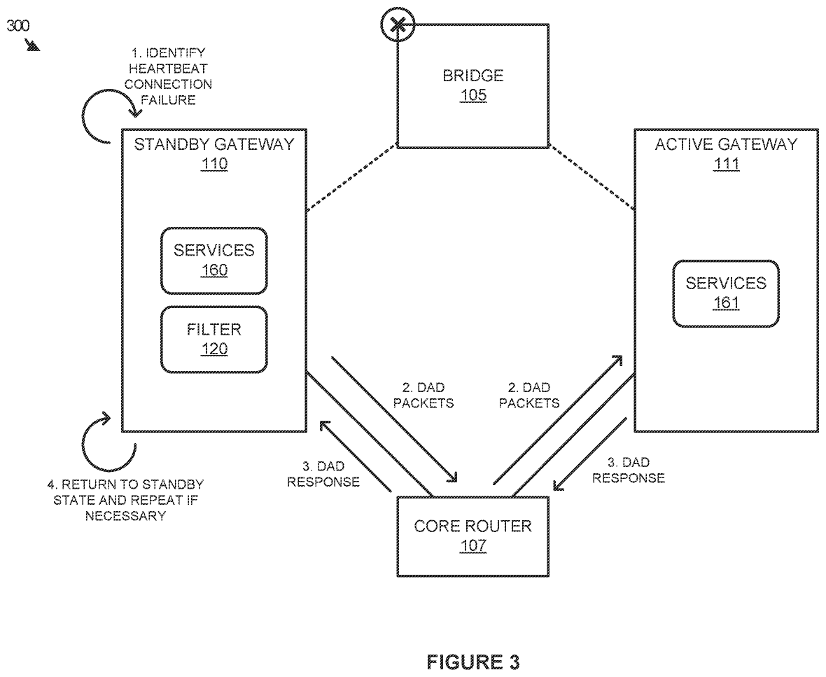

FIG. 3 illustrates an operational scenario 300 of using DAD packets to determine that the active gateway is available according to an implementation. Operational scenario 300 includes gateways 110-111, bridge 105, and core router 107 from computing environment 100 of FIG. 1. Operational scenario 300 further includes services 160 and filter 120 on standby gateway 110, and service 161 on active gateway 111 from computing environment 100 of FIG. 1.

During the operation of gateways 110-111, gateways 110-111 exchange status information, such as heartbeat packets, that indicate the health associated with the gateways. Here, standby gateway 110 identifies, at step 1, a heartbeat connection failure with active gateway 111, wherein the failure could be caused by the failure of active gateway 111 or the bridge connection (demonstrated here) between standby gateway 110 and active gateway 111. In some examples, the failure can be identified when a heartbeat packet is not received by standby gateway 110 within a timeout period. In response to identifying the heartbeat connection failure, standby gateway applies filter 120 and communicates one or more DAD packets in the data plane at step 2. The filter is used to permit the communication of DAD related packets, while blocking one or more other protocols. Thus, while DAD packets are permitted, other packets will be dropped until the failure of active gateway 111 is confirmed. The DAD packets can be communicated via the ports that are coupled to the data plane and the shared core router 107.

After applying filter 120 and communicating the DAD packets, standby gateway 110 will initiate a timer to determine whether a response to the DAD packets is received in a timeout period. When DAD packet response is received at step 3 within the timeout period, standby gateway 110 returns to the standby state at step 4, wherein returning to the standby state can remove the implementation of filter 120. The removal of the filter will prevent any packets from being accepted by standby gateway 110. Additionally, if the duration of the heartbeat failure exceeds a threshold time steps 2 and 3 above can be repeated to determine whether active gateway 111 is still available. For example, if after returning to the standby state, the heartbeat connection remains unavailable for a threshold period, standby gateway 110 can apply filter 120 and send one or more second DAD packets in the data plane on the core router 107 side of standby gateway 110. If active gateway 111 is available, active gateway 111 will send a response to the DAD packets indicating that the IP addresses are still in use. In response to receiving the packets, standby gateway 110 will return to the standby state, wherein the standby state prevents packets from being processed via standby gateway 110. In contrast, if a response is not provided in the timeout period, standby gateway 110 can move to an active state and implement service 160 that are a duplicate of services 161. In moving to the active state, standby gateway 110 will remove the filters that are used to prevent the processing of data packets associated with protocols outside of the DAD packets. This will permit standby gateway 110 to receive packets at the IP addresses formerly used by active gateway 111 and implement services 160 for the packets. When the heartbeat connection is reestablished via bridge 105, standby gateway 110 can pass off the active state to active gateway 111, wherein standby gateway 110 can return to the standby state. Alternatively, once the heartbeat connection is reestablished, active gateway 111 can provide the standby state and communicate state information via the heartbeat connection.

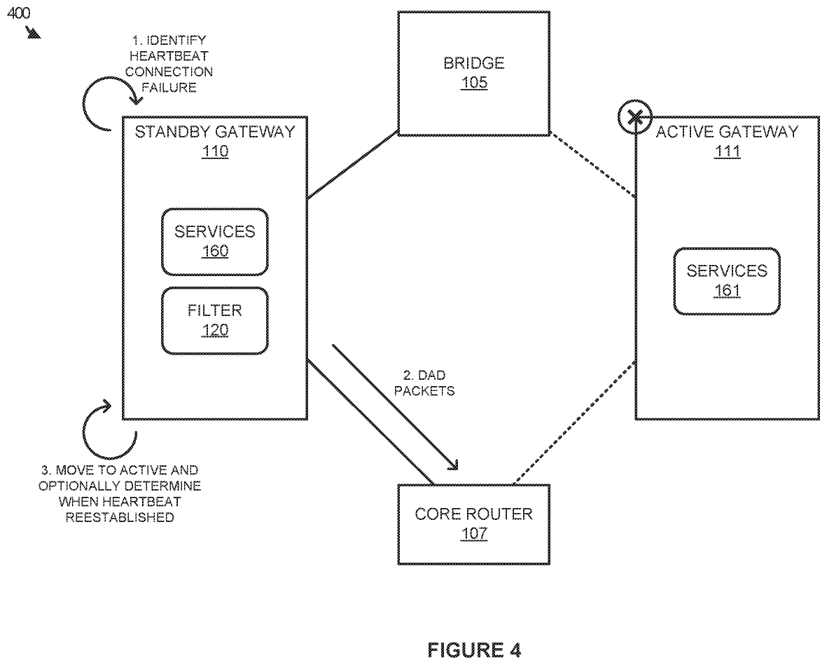

FIG. 4 illustrates an operational scenario 400 of using DAD packets to determine that the active gateway is unavailable according to an implementation. Operational scenario 400 includes gateways 110-111, bridge 105, and core router 107 from computing environment 100 of FIG. 1. Operational scenario 400 further includes services 160 and filter 120 on standby gateway 110, and service 161 on active gateway 111 from computing environment 100 of FIG. 1.

During the operation of gateways 110-111, gateways 110-111 exchange status information, such as heartbeat packets, that indicate the health associated with the gateways. Here, standby gateway 110 identifies, at step 1, a heartbeat connection failure with active gateway 111, wherein the failure could be caused by the failure of active gateway 111 or the bridge connection (demonstrated here) between standby gateway 110 and active gateway 111. In some examples, the failure can be identified when a heartbeat packet is not received by standby gateway 110 within a timeout period. In response to identifying the heartbeat connection failure, standby gateway applies filter 120 and communicates one or more DAD packets in the data plane at step 2. The filter is used to permit the communication of DAD related packets, while blocking one or more other protocols. Thus, while DAD packets are permitted, other packets will be dropped until the failure of active gateway 111 is confirmed. The DAD packets can be communicated via the ports that are coupled to the data plane and the shared core router 107.

After applying filter 120 and communicating the DAD packets, standby gateway 110 will wait for a response to the one or more DAD packets during a timeout period. Here, because of the failure to active gateway 111 (hardware, software, or some other failure), no response will be provided to the DAD packets sent by standby gateway 110. After the expiration of the timeout period, standby gateway 110 moves to the active state at step 3, wherein moving to the active state removes the filter to block packets associated with protocols other than those related to DAD packets and implements services 160. In the active state standby gateway 110 may assume the IP addresses that were otherwise used in association with active gateway 111. This allows packets that would otherwise be addressed to the active gateway to be delivered to standby gateway 110.

In some implementations, after moving to the active state, standby gateway 110 will determine when the heartbeat connection is reestablished with active gateway 111. The connection is reestablished when active gateway is available and communicates with standby gateway 110 via bridge 105. Once the connection is reestablished, standby gateway 110 can remain the active gateway in the peered relationship with active gateway 111 or can transition active gateway 111 back to the active state. When moving active gateway 111 back to the active state, standby gateway 110 can move to the standby state such that packets data packets are not processed at standby gateway 110.

Although demonstrated with a complete failure associated with active gateway 111, some failures may occur in association with the WAN connection to the one or more computing devices and/or core router 107. With these failures, active gateway 111, can communicate via the heartbeat connection over bridge 105 a notification to standby gateway 110 to trigger the transition to the active gateway. Accordingly, when the heartbeat connection is available to support the status communications between the gateways, the standby gateway can transition to the active state based on the notification from the active gateway. When the heartbeat connection is not available (identified via a timeout), then the standby gateway can use the exchange of DAD packets to determine whether the active gateway continues to use the same IP addresses.

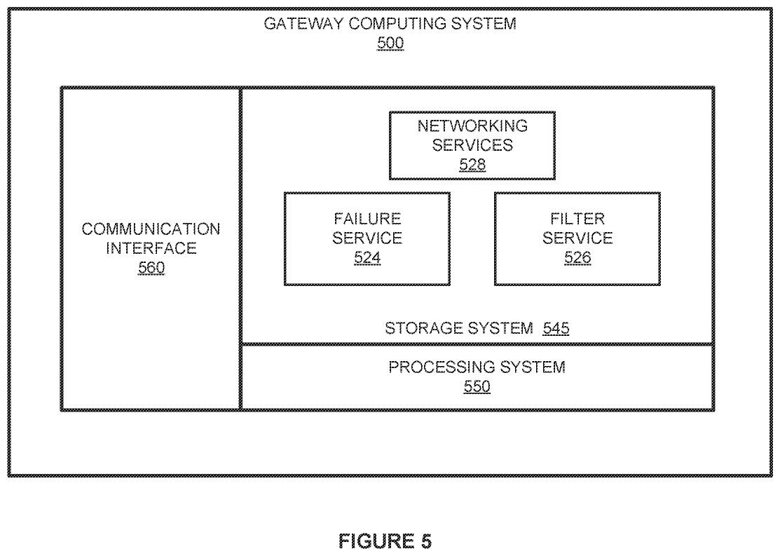

FIG. 5 illustrates a gateway computing system that uses DAD packets to determine whether to transition from a standby to an active state according to an implementation. Computing system 500 is representative of any computing system or systems with which the various operational architectures, processes, scenarios, and sequences disclosed herein for a management service can be implemented. Computing system 500 is an example of management services 105 and 320 from FIGS. 1 and 3, respectively, although other examples may exist. Computing system 500 includes storage system 545, processing system 550, and communication interface 560. Processing system 550 is operatively linked to communication interface 560 and storage system 545. Communication interface 560 may be communicatively linked to storage system 545 in some implementations. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format-including combinations thereof. Communication interface 560 can communicate with other gateways, core routers, hosts, or other computing systems to provide an edge gateway as described herein. In some examples, communication interface 560 can further communicate with a control service computing system capable of configuring the services on gateway computing system 500.

Processing system 550 comprises microprocessor and other circuitry that retrieves and executes operating software from storage system 545. Storage system 545 may include volatile and nonvolatile, removable, and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises configuration service 524 and update service 526. The operating software on storage system 545 may further include an operating system, utilities, drivers, network interfaces, applications, or some other type of software. When read and executed by processing system 550 the operating software on storage system 545 directs computing system 500 to operate as described herein. In at least one example, the operating software can provide at least method 200 described above in FIG. 2.

In at least one implementation, gateway computing system 500 is representative of a standby gateway associated with an active gateway (not shown). Communication interface 560 can use a bridge as a heartbeat connection that provides status information between the active gateway and the standby gateway. Failure service 524 directs processing system 550 to determine when a failure occurs in association with the heartbeat connection with the active gateway. In some implementations, failure service 524 identifies the failure when a heartbeat message is not received from the active gateway within a timeout period. After identifying the failure, filter service 526 directs processing system 550 to implement a filter that permits DAD related packets and maintains a block of other protocol traffic. In addition to implementing the filter, filter service 526 generates one or more DAD packets that are communicated in the data plane, wherein the DAD packets will indicate the IP address or addresses associated with the standby gateway (i.e., the same IP address or addresses associated with the active gateway). The one or more DAD packets can be communicated via one or more ports coupled to the data plane and capable of communicating to the active gateway.

After communicating the one or more DAD packets, filter service 526 directs processing system 550 to determine whether a response to the one or more DAD packets is delivered in a timeout period. If a response is delivered within the timeout period, then filter service 526 directs processing system to return to the standby state, wherein the standby state stops gateway computing system 500 from processing packets in the data plane. Alternatively, if a response is not communicated within the timeout period, filter service 526 directs processing system 550 to move to an active state and implement networking services 528 for the data plane. Networking service 528 are duplicates of the services that are provided by the active gateway and can be used to provide firewall services, encapsulation services, routing services, or other types of gateway services.

In some implementations, when the gateway returns to a standby state based on the receipt of the response to the DAD packet, failure service 524 can direct processing system to determine whether the failure associated with the heartbeat connection exceeds a threshold period. The failure exceeds a threshold period, failure service 524 can direct processing system 550 to repeat the DAD operations described previously. In at least one example, filter service 526 will direct processing system 550 to activate a filter that permits DAD related packet communications while blocking other protocols from being processed in the data plane. Once the filter is active, filter service 526 can communicate DAD packets and determine whether a response to the DAD packets is received within a timeout period. Filter service 526 will then revert to the standby state or move to the active state based on whether a response was received in the timeout period. The operation can be repeated as necessary until the heartbeat connection is reestablished between the active and the standby gateways. In some examples, where the heartbeat connection is reestablished, failure service 52 will not take further action with respect to sending DAD packets to the active gateway.

In some implementations, when filter service 526 directs processing system 550 to move gateway computing system 500 to the active state, failure service 524 can direct processing system 550 to monitor for the reestablishment of the heartbeat connection with the previously active gateway. Once reestablished, failure service 524 can direct processing system 550 to move gateway computing system 500 back to the standby state, wherein the other gateway in the pair can be moved to the active state. In other examples, gateway computing system 500 will assume the active state, while the other gateway moves to the standby state. The gateways will then exchange heartbeat and status information as was done prior to the failure.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a first gateway comprising:
maintaining a standby state for a second gateway in an active state;
identifying a loss of a heartbeat connection with the second gateway;
in response to identifying the loss of the heartbeat connection, applying a packet filter in a data plane, wherein the packet filter permits Duplicate Address Detection (DAD) packets and blocks remaining packets;
communicating one or more DAD packets in the data plane;
determining whether a response to the one or more DAD packets is received within a timeout period;
when a response to the one or more DAD packets is received within the timeout period, returning to the standby state; and
when a response to the one or more DAD packets is not received within the timeout period, moving to the active state.

2. The method of claim 1, wherein the standby state comprises a state to drop incoming packets in the data plane.

3. The method of claim 1, wherein the active state comprises a state to process incoming packets from the data plane.

4. The method of claim 1 further comprising:
when a response to the one or more DAD packets is received within the timeout period:
determining when a time associated with the loss of heartbeat exceeds a threshold;
communicating one or more second DAD packets in the data plane;
determining whether a response to the one or more second DAD packets is received within a second timeout period; and
when a response to the one or more second DAD packets is received within the second timeout period, returning to the standby state; and
when a response to the one or more second DAD packets is not received within the second timeout period, moving to the active state.

5. The method of claim 1 further comprising:
when a response to the one or more DAD packets is not received within the timeout period:
identifying a reestablishment of the heartbeat connection with the second gateway;
in response to the reestablishment of the heartbeat connection, moving to the standby state.

6. The method of claim 1, wherein identifying the loss of the heartbeat connection with the second gateway comprises identifying when a heartbeat packet from the second gateway is not received during a heartbeat timeout.

7. The method of claim 1, wherein communicating the one or more DAD packets in the data plane comprises communicating the one or more DAD packets via one or more ports of the first gateway associated with the data plane.

8. A computing apparatus comprising:
a storage system;
a processing system operatively coupled to the storage system; and
program instructions stored on the storage system to operate a first gateway that, when executed by the processing system, direct the computing apparatus:
maintain a standby state for a second gateway in an active state;
identify a loss of a heartbeat connection with the second gateway;
in response to identifying the loss of the heartbeat connection, apply a packet filter in a data plane, wherein the packet filter permits Duplicate Address Detection (DAD) packets and blocks remaining packets;
communicate one or more DAD packets in the data plane;
determine whether a response to the one or more DAD packets is received within a timeout period;
when a response to the one or more DAD packets is received within the timeout period, return to the standby state; and
when a response to the one or more DAD packets is not received within the timeout period, move to the active state.

9. The computing apparatus of claim 8, wherein the standby state comprises a state to drop incoming packets in the data plane.

10. The computing apparatus of claim 8, wherein the active state comprises a state to process incoming packets from the data plane.

11. The computing apparatus of claim 8, wherein the program instructions further direct the computing apparatus to:
when a response to the one or more DAD packets is received within the timeout period:
determine when a time associated with the loss of heartbeat exceeds a threshold;
communicate one or more second DAD packets in the data plane;
determine whether a response to the one or more second DAD packets is received within a second timeout period; and
when a response to the one or more second DAD packets is received within the second timeout period, return to the standby state; and
when a response to the one or more second DAD packets is not received within the second timeout period, move to the active state.

12. The computing apparatus of claim 8, wherein the program instructions further direct the computing apparatus to:
when a response to the one or more DAD packets is not received within the timeout period:
identify a reestablishment of the heartbeat connection with the second gateway;
in response to the reestablishment of the heartbeat connection, move to the standby state.

13. The computing apparatus of claim 8, wherein identifying the loss of the heartbeat connection with the second gateway comprises identifying when a heartbeat packet from the second gateway is not received during a heartbeat timeout.

14. The computing apparatus of claim 8, wherein communicating the one or more DAD packets in the data plane comprises communicating the one or more DAD packets via one or more ports of the first gateway associated with the data plane.

15. A system comprising:
a first gateway; and
a second gateway;
the first gateway configured to:
maintain a standby state for a second gateway in an active state;
identify a loss of a heartbeat connection with the second gateway;
in response to identifying the loss of the heartbeat connection, apply a packet filter in a data plane, wherein the packet filter permits Duplicate Address Detection (DAD) packets and blocks remaining packets;
communicate one or more DAD packets in the data plane;
determine whether a response to the one or more DAD packets is received within a timeout period;
when a response to the one or more DAD packets is received within the timeout period, return to the standby state; and
when a response to the one or more DAD packets is not received within the timeout period, move to the active state.

16. The system of claim 15, wherein the standby state comprises a state to drop incoming packets in the data plane.

17. The system of claim 15, wherein the active state comprises a state to process incoming packets from the data plane.

18. The system of claim 15, wherein the first gateway is further configured to:
when a response to the one or more DAD packets is not received within the timeout period:
identifying a reestablishment of the heartbeat connection with the second gateway;
in response to the reestablishment of the heartbeat connection, moving to the standby state.

19. The system of claim 15, wherein identifying the loss of the heartbeat connection with the second gateway comprises identifying when a heartbeat packet from the second gateway is not received during a heartbeat timeout.

20. The system of claim 15, wherein communicating the one or more DAD packets in the data plane comprises communicating the one or more DAD packets via one or more ports of the first gateway associated with the data plane.
